(19) United States
(12) Patent Application Publication
(10) Pub. No.: US 2022/0313526 A1
(43) Pub. Date: Oct. 6, 2022

(54) BED AND MATTRESS AUTO SETTINGS FOR INTUBATION

(71) Applicant: Hill-Rom Services, Inc., Batesville, IN (US)

(72) Inventors: Philippe KAIKENGER, Pluvigner (FR); Jean-Bernard DUVERT, Baud (FR); Mickael AUDIC, Locmiquelic (FR); Anthony THEPAUT, Pluneret (FR); Etienne YVERNAULT, BRECH (FR); Herve GAUTIER, Plumergat (FR); Clementine PIRIO, Nantes (FR)

(21) Appl. No.: 17/685,426

(22) Filed: Mar. 3, 2022

Related U.S. Application Data
(60) Provisional application No. 63/167,791, filed on Mar. 30, 2021.

(51) Int. Cl. A61G 13/12; A61G 13/06; A61G 13/08; A61G 13/10

(52) U.S. Cl. CPC A61G 13/1215; A61G 13/06; A61G 13/08; A61G 13/1265; A61G 13/107

(57) ABSTRACT

A patient support apparatus includes a frame having a head section moveably coupled to a seat section. At least one frame actuator is configured to raise and lower the frame relative to a floor. At least one head section actuator is configured to adjust an angle of the head section relative to the seat section. A patient support surface is positioned on the frame. The patient support surface includes a plurality of bladders. An air source is configured to inflate and deflate the plurality of bladders. A sensor is configured to detect the presence of a caregiver at a head end of the frame. A control circuitry adjusts a position of the frame in response to a command from a caregiver.

### CROSS-REFERENCE TO RELATED APPLICATIONS

This application claims priority under 35 U.S.C. § 119(e) to U.S. Provisional Application No. 63/167,791, filed Mar. 30, 2021, which is expressly incorporated by reference herein.

### BACKGROUND

The present disclosure relates to a patient support apparatus and, more particularly, to a patient support apparatus having automatic settings for intubation.

The optimal position for direct laryngoscopy brings the laryngeal axis, the pharyngeal axis and the axis of the mouth into alignment with a line of vision of a caregiver. Generally, one caregiver holds the neck of the patient, when the patient lying, to allow a better visibility of the alignment for a second caregiver who places the intubation line. Recent studies show that the best alignment of the axes is achieved when a head of bed angle is at approximately 45 degrees with a bed height allowing the head of bed axis to be aligned with the caregiver ombilicus. Another appropriate head of bed angle is at 25 degrees, wherein the bed position is relative to the caregiver's size. Allowing the bed to automatically reach an optimal position would facilitate faster intubation times.

### SUMMARY

The present disclosure includes one or more of the features recited in the appended claims and/or the following features which, alone or in any combination, may comprise patentable subject matter.

According to a first aspect of the disclosed embodiments, a patient support apparatus includes a frame having a head section moveably coupled to a seat section. At least one frame actuator is configured to raise and lower the frame relative to a floor. At least one head section actuator is configured to adjust an angle of the head section relative to the seat section. A patient support surface is positioned on the frame. The patient support surface includes a plurality of bladders. An air source is configured to inflate and deflate the plurality of bladders. A sensor is configured to detect the presence of a caregiver at a head end of the frame. A control circuitry includes a processor and a non-transitory memory device. The memory device includes instructions that, when executed by the processor, adjust a position of the frame in response to a command from a caregiver. In response to the command, the control circuitry operates the at least one head section actuator to adjust the angle of the head section relative to the seat section to a predetermined angle. In response to the command, the control circuitry receives a status of the sensor to detect a height of the caregiver. In response to the command, the control circuitry operates the at least one frame actuator to adjust a height of the frame based on the detected height of the caregiver. In response to the command, the control circuitry further operates the air source to inflate at least one of the plurality of bladders.

In some embodiments of the first aspect, the predetermined angle may include 25 degree angle. The predetermined angle may include a 45 degree angle. In response to the command, the control circuitry may also operate the air source to inflate the at least one of the plurality of bladders to a maximum volume. The sensor may detect the height of the caregiver by scanning the caregiver. The control circuitry may operate the at least one frame actuator to adjust the height of the frame based on the detected height of the caregiver relative to the golden ratio. The at least one frame actuator may adjust the height of the frame so that a head of bed axis is aligned with an ombilicus of the caregiver. The at least one frame actuator may adjust the height of the frame so that a laryngeal axis of a patient on the patient support surface is approximately aligned with a line of vision of the caregiver. The at least one frame actuator may adjust the height of the frame so that a pharyngeal axis of a patient on the patient support surface is approximately aligned with a line of vision of the caregiver. The at least one frame actuator may adjust the height of the frame so that an oral axis of a mouth of a patient on the patient support surface is approximately aligned with a line of vision of the caregiver. An activation button may be provided. The command from the caregiver may be received when the activation button is actuated. The command from the caregiver may be received when a patient positioned on the patient support surface requires intubation. The source of air may include at least one of a fan, a blower, a pump, and a compressor.

According to a second aspect of the disclosed embodiments, a patient support apparatus includes a frame having a head section moveably coupled to a seat section. At least one frame actuator is configured to raise and lower the frame relative to a floor. At least one head section actuator is configured to adjust an angle of the head section relative to the seat section. A patient support surface is positioned on the frame. A sensor is configured to detect the presence of a caregiver at a head end of the frame. A control circuitry includes a processor and a non-transitory memory device. The memory device includes instructions that, when executed by the processor, adjust a position of the frame in response to a command from a caregiver. In response to the command, the control circuitry operates the at least one head section actuator to adjust the angle of the head section relative to the seat section to a predetermined angle. In response to the command, the control circuitry receives a status of the sensor the sensor to detect a height of the caregiver. In response to the command, the control circuitry operates the at least one frame actuator to adjust a height of the frame based on the detected height of the caregiver.

In some embodiments of the second aspect, the predetermined angle may include at least one of a 25 degree angle and a 45 degree angle. The sensor may detect the height of the caregiver by scanning the caregiver. The control circuitry may operate the at least one frame actuator to adjust the height of the frame based on the detected height of the caregiver relative to the golden ratio. The at least one frame actuator may adjust the height of the frame so that a head of bed axis is aligned with an ombilicus of the caregiver. The at least one frame actuator may adjust the height of the frame so that at least one of a laryngeal axis of a patient on the patient support surface is approximately aligned with a line of vision of the caregiver, a pharyngeal axis of the patient on the patient support surface is approximately aligned with the line of vision of the caregiver, and an oral axis of a mouth of the patient on the patient support surface is approximately aligned with the line of vision of the caregiver. The command from the caregiver may be received when a patient positioned on the patient support surface requires intubation.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a block diagram showing electrical circuitry of the patient support apparatus;

FIG. 2 is a side elevation view of the patient support apparatus having an axis of the head end aligned with a caregiver's ombilicus when the head end is at an angle of approximately 45 degrees relative to the foot section; and

FIG. 3 is a side elevation view of the patient support apparatus having an axis of the head end aligned with a caregiver's ombilicus when the head end is at an angle of approximately 25 degrees relative to the foot section.

### DETAILED DESCRIPTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

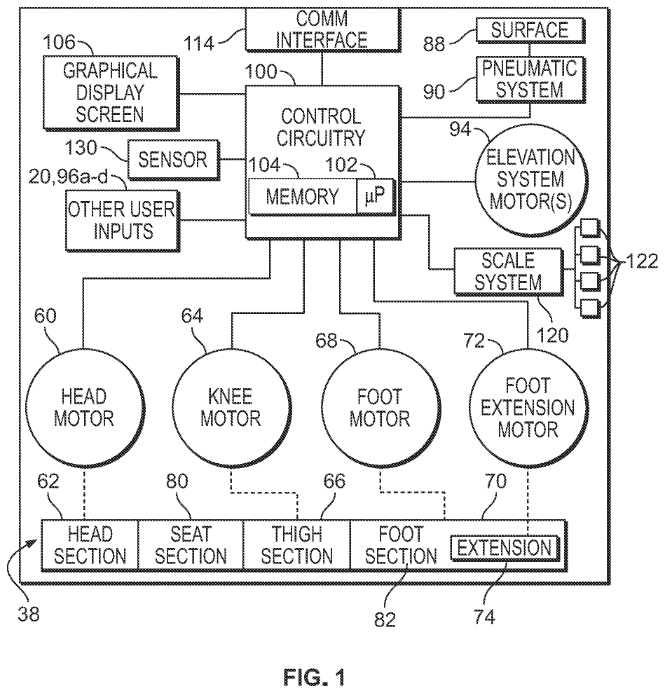

As shown diagrammatically in FIG. 1, a patient support apparatus 14 includes a head section 62, a seat section 80, a thigh section 66, a foot section 70, and a foot extension 74. The patient support apparatus 14 includes a head motor or actuator 60 coupled to the head section 62, a knee motor or actuator 64 coupled to the thigh section 66, a foot motor or actuator 68 coupled to the foot section 70, and a foot extension motor or actuator 72 coupled to the foot extension 74. The motors 60, 64, 68, 72 may include, for example, an electric motor of a linear actuator. In those embodiments in which the seat section 80 translates along an upper frame, a seat motor or actuator (not shown) is also provided. The head motor 60 is operable to raise and lower the head section 62 relative to the seat section 80, the knee motor 64 is operable to articulate the thigh section 66 relative to the seat section 80, the foot motor 68 is operable to raise and lower the foot section 70 relative to the thigh section 66, and the foot extension motor 72 is operable to extend and retract the extension 74 of the foot section 70 relative to the main portion 82 of the foot section 70.

In some embodiments, the patient support apparatus 14 includes a pneumatic system 90 that controls inflation and deflation of various air bladders or cells of a mattress 88 of the patient support apparatus 14. The pneumatic system 90 is represented in FIG. 1 as a single block, but that block 90 is intended to represent one or more air sources (e.g., a fan, a blower, a compressor, a pump) and associated valves, manifolds, air passages, air lines or tubes, pressure sensors, and the like, as well as the associated electric circuitry, that are typically included in a pneumatic system for inflating and deflating air bladders of mattresses.

As also shown diagrammatically in FIG. 1, a lift system of the patient support apparatus 14 includes one or more elevation system motors or actuators 94, which in some embodiments, comprise linear actuators with electric motors. Thus, the actuators 94 are sometimes referred to herein as motors 94. Alternative actuators or motors contemplated by this disclosure include hydraulic cylinders and pneumatic cylinders, for example. The motors 94 of the lift system are operable to raise, lower, and tilt an upper frame assembly relative to a base. In the illustrative embodiment, one of the motors 94 is coupled to, and acts upon, a set of head end lift arms and another of the motors 94 is coupled to, and acts upon, a set of foot end lift arms to accomplish the raising, lowering and tilting functions of the upper frame relative to the base.

In the illustrative example, the patient support apparatus 14 has four foot pedals 96a, 96b, 96c, 96d. The foot pedal 96a is used to raise the upper frame assembly relative to the base, the foot pedal 96b is used to lower the frame assembly relative to the base, the foot pedal 96c is used to raise the head section 60 relative to the frame, and the foot pedal 96d is used to lower the head section 60 relative to the frame. In other embodiments, the foot pedals 96a-d are omitted.

A user inputs block 20 includes various buttons that are used by a caregiver (not shown) to control associated functions of the patient support apparatus 14. For example, the user inputs block 20 includes buttons that are used to operate the head motor 62 to raise and lower the head section 60, buttons that are used to operate the knee motor 66 to raise and lower the thigh section 64, and buttons that are used to operate the motors 94 to raise, lower, and tilt the upper frame assembly relative to the base. The user inputs block 20 also includes buttons that are used to operate the motor 68 to raise and lower the foot section 70 and buttons that are used to operate the motor 72 to extend and retract the foot extension 70 relative to the main portion 82. In the illustrative embodiment, the user inputs block 20 includes an intubation button to activate an intubation mode of the patient support apparatus 14, wherein the intubation mode tilts the head section 60 relative to the seat section 80 to a predetermined angle and raises or lowers the upper frame assembly relative to the base to a calculated height. In some embodiments, the buttons of control panels 20 include membrane switches. In some embodiments, the buttons of the user inputs block 20 include touch-screen icons.

As shown diagrammatically in FIG. 1, the patient support apparatus 14 includes a control circuitry 100 that is electrically coupled to the motors 60, 64, 68, 72 and to the motors 94 of the lift system. The control circuitry 100 is represented diagrammatically as a single block in FIG. 1, but the control circuitry 100 in some embodiments comprises various circuit boards, electronics modules, and the like that are electrically and communicatively interconnected. The control circuitry 100 includes one or more microprocessors 102 or microcontrollers that execute software to perform the various control functions and algorithms described herein. Thus, the control circuitry 100 also includes a memory 104 for storing software, variables, calculated values, and the like as is well known in the art.

As also shown diagrammatically in FIG. 1, the user inputs block 20 represents the various user inputs such as buttons of a control panel and the pedals 96a-d, for example, that are used by the caregiver or patient to communicate input signals to the control circuitry 100 of the patient support apparatus 14 to command the operation of the various motors 60, 64, 68, 72 of the patient support apparatus 14, as well as commanding the operation of other functions of the patient support apparatus 14. The patient support apparatus 14 includes at least one graphical user input or display screen 106. The display screen 106 is coupled to the control circuitry 100 as shown diagrammatically in FIG. 1. In some embodiments, two graphical user interfaces 106 are provided. Alternatively or additionally, one or more graphical user interfaces are coupled to the siderails and/or to one or both of the headboard and footboard of the patient support apparatus 14. The control circuitry 100 receives user input commands from the graphical display screen 106.

The control circuitry 100 of the patient support apparatus 14 may communicate with the remote devices via communication infrastructure such as an Ethernet of a healthcare facility in which the patient support apparatus 14 is located and via communications links. The remote computers may be part of an electronic medical records (EMR) system. However, the circuitry 100 of the patient support apparatus 14 may communicate with other computers such as those included as part of a nurse call system, a physician ordering system, an admission/discharge/transfer (ADT) system, or some other system used in a healthcare facility in other embodiments. In the illustrative embodiment, patient support apparatus 14 has a communication interface or port 114 which provides bidirectional communication remote computers.

The patient support apparatus 14 also includes a scale system 120 as shown diagrammatically in FIG. 1. The scale system 120 includes one or more weight sensors that are indicative of the weight of the patient on patient support apparatus 14. In some embodiments, the scale system 120 includes four load cells 122 (e.g., load beams with strain gages) that interconnect a lift frame with a weigh frame adjacent the four corners of the frame. In addition to sensing an amount of weight of the patient, the data from the sensors of the scale system 120 is also used by the control circuitry 100 to determine the patient's position relative to the patient support apparatus 14. Thus, in the illustrative example, data from the sensors of the weigh scale system 120 is compared to thresholds associated with the Exiting, Out-of-Bed, and Patient Position modes of the PPM system to determine if an alarm condition exists.

The patient support apparatus also includes a sensor 130 to detect the presence of a caregiver at a head end of the patient support apparatus 14. In some embodiments, the sensor 130 is coupled to the head section 60 of the patient support apparatus 14. The sensor 130 may be an infrared sensor, an ultrasonic sensor, a capacitive sensor, a camera, or any other suitable sensor for detecting the presence of an object, e.g. caregiver. The control circuitry 100 operates the sensor 130 in response to the activation of the intubation button described above. The control circuitry 100 operates the motors 94 to raise or lower the upper frame assembly relative to the base to a height that is calculated, as described in more detail below, based on the sensor 130 detecting the presence of the caregiver at the head end of the patient support apparatus 14.

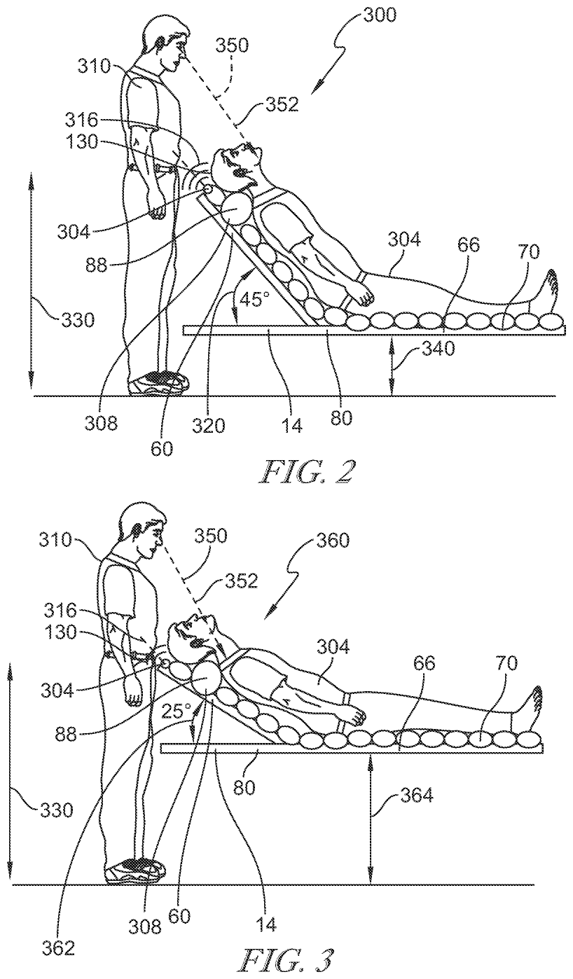

Referring to FIG. 2, the patient support apparatus 14 is illustrated in an exemplary intubation position 300. In some embodiments, the patient support apparatus 14 automatically moves to the position 300 in response to a caregiver 310 user activating the intubation button of the inputs block 20. In an exemplary embodiment, the intubation button of the inputs block 20 is positioned at a head end 302 of the patient support apparatus 14, for example, on the head section 60 of the patient support apparatus 14. That is, when the caregiver 310 intends to intubate the patient 304 on the patient support apparatus 14, the caregiver 310 moves to the head end 302 of the patient support apparatus 14 and activates the intubation button of the inputs block 20.

In response to activating the intubation button of the inputs block 20, the control circuitry 100 activates the pneumatic system 90 to inflate at least one of the various air bladders or cells 308 of the mattress 88 to a predetermined volume. In some embodiments, the predetermined volume is a maximum volume of the at least one of the various air bladders or cells 308 of the mattress 88. By inflating the various air bladders or cells 308 of the mattress 88 to a predetermined volume, the mattress 88 provides support for the head and neck of the patient 304 during intubation. For example, the at least one of the plurality of bladders 308 that is inflated may be a bladder 308 positioned under the patient's head or neck.

In response to activating the intubation button of the inputs block 20, the control circuitry 100 also activates the head motor 62 to raise or lower the head section 60 to a predetermined angle 320 relative to the seat section 80. In the exemplary embodiment, the head section 60 is raised or lowered to a predetermined angle 320 of 45 degrees relative to the seat section 80. It will be appreciated that, in response to activating the intubation button of the inputs block 20, the control circuitry 100 may also activate the knee motor 64, the foot motor 68, and the foot extension motor to positioned the seat section 80, the thigh section 66, and the foot section 70 in a linear configuration, e.g. parallel to the floor.

In response to activating the intubation button of the inputs block 20, the control circuitry 100 also activates the sensor 130 to detect a presence of the caregiver 310 at the head end 302 of the patient support apparatus 14. The sensor 130 determines a height of the caregiver 310. The height of the caregiver 310 is calculated by scanning the caregiver 310 from the floor to a top of the caregiver's head. Once the sensor passes over the caregiver's head, the caregiver 310 is no longer detected and a height of the caregiver 310 may be determined based on the angle of the sensor when the caregiver 310 is no longer detected. By determining the height of the caregiver 310, the control circuitry can calculate a height 330 of the ombilicus of the caregiver 310 using the caregiver's height and the golden ratio, wherein the golden ratio is known to be 1.6180339887. That is the caregiver's height is divided by the golden ration to determine the height 330 of the ombilicus of the caregiver 310. The control circuitry 100 then activates the motors 94 to raise or lower the upper frame assembly to a calculated height 340. In the exemplary embodiment, the calculated height 340 is the height where a head of bed axis 316, or an axis of the head section 60, is aligned with an ombilicus of the caregiver 310.

FIG. 2 illustrates the patient support apparatus 14 at the calculated height 340. At the calculated height 340, a line of vision 350 of the caregiver 310 is approximately aligned with an axis 352 of the patient 304. The axis 352 of the patient 304 is approximately aligned with a laryngeal axis of the patient 304. The axis 352 of the patient 304 is approximately aligned with a pharyngeal axis of the patient 304. The axis 352 of the patient 304 is approximately aligned with an oral axis of a mouth of the patient 304. In the position illustrated in FIG. 2, the line of vision 350 of the caregiver 310 facilitates intubating the patient 304.

Referring now to FIG. 3, the patient support apparatus 14 is illustrated in an exemplary intubation position 360. In some embodiments, the patient support apparatus 14 automatically moves to the position 360 in response to a caregiver 310 user activating the intubation button of the inputs block 20. In an exemplary embodiment, the intubation button of the inputs block 20 is positioned at a head end 302 of the patient support apparatus 14, for example, on the head section 60 of the patient support apparatus 14. That is, when the caregiver 310 intends to intubate the patient 304 on the patient support apparatus 14, the caregiver 310 moves to the head end 302 of the patient support apparatus 14 and activates the intubation button of the inputs block 20.

In response to activating the intubation button of the inputs block 20, the control circuitry 100 activates the pneumatic system 90 to inflate at least one of the various air bladders or cells 308 of the mattress 88 to a predetermined volume. In some embodiments, the predetermined volume is a maximum volume of the at least one of the various air bladders or cells 308 of the mattress 88. By inflating the various air bladders or cells 308 of the mattress 88 to a predetermined volume, the mattress 88 provides support for the head and neck of the patient 304 during intubation. For example, the at least one of the plurality of bladders 308 that is inflated may be a bladder 308 positioned under the patient's head or neck.

In response to activating the intubation button of the inputs block 20, the control circuitry 100 also activates the head motor 62 to raise or lower the head section 60 to a predetermined angle 362 relative to the seat section 80. In the exemplary embodiment, the head section 60 is raised or lowered to a predetermined angle 362 of 45 degrees relative to the seat section 80. It will be appreciated that, in response to activating the intubation button of the inputs block 20, the control circuitry 100 may also activate the knee motor 64, the foot motor 68, and the foot extension motor to positioned the seat section 80, the thigh section 66, and the foot section 70 in a linear configuration, e.g. parallel to the floor.

In response to activating the intubation button of the inputs block 20, the control circuitry 100 also activates the sensor 130 to detect a presence of the caregiver 310 at the head end 302 of the patient support apparatus 14. The sensor 130 determines a height of the caregiver 310. The height of the caregiver 310 is calculated by scanning the caregiver 310 from the floor to a top of the caregiver's head. Once the sensor passes over the caregiver's head, the caregiver 310 is no longer detected and a height of the caregiver 310 may be determined based on the angle of the sensor when the caregiver 310 is no longer detected. By determining the height of the caregiver 310, the control circuitry can calculate a height 330 of the ombilicus of the caregiver 310 using the caregiver's height and the golden ratio, wherein the golden ratio is known to be 1.6180339887. That is the caregiver's height is divided by the golden ration to determine the height 330 of the ombilicus of the caregiver 310. The control circuitry 100 then activates the motors 94 to raise or lower the upper frame assembly to a calculated height 364. In the exemplary embodiment, the calculated height 364 is the height where a head of bed axis 316, or an axis of the head section 60, is aligned with an ombilicus of the caregiver 310.

FIG. 3 illustrates the patient support apparatus 14 at the calculated height 364. At the calculated height 340, a line of vision 350 of the caregiver 310 is approximately aligned with an axis 352 of the patient 304. The axis 352 of the patient 304 is approximately aligned with a laryngeal axis of the patient 304. The axis 352 of the patient 304 is approximately aligned with a pharyngeal axis of the patient 304. The axis 352 of the patient 304 is approximately aligned with an oral axis of a mouth of the patient 304. In the position illustrated in FIG. 3, the line of vision 350 of the caregiver 310 facilitates intubating the patient 304.

The disclosed embodiments facilitate patient support apparatus position auto adjustment and air mattress auto adjustment to enable an easier and faster intubation. In the disclosed embodiments, the bed adjustment is relative to the caregiver height.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless cannot be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used, the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles have been presented, they need not be utilized in combination, and many combinations of aspects and principles are possible in light of the various embodiments provided above.

1. A patient support apparatus, comprising:
a frame having a head section moveably coupled to a seat section,
at least one frame actuator configured to raise and lower the frame relative to a floor,
at least one head section actuator configured to adjust an angle of the head section relative to the seat section,
a patient support surface positioned on the frame, the patient support surface including a plurality of bladders,
an air source configured to inflate and deflate the plurality of bladders,
a sensor configured to detect the presence of a caregiver at a head end of the frame, and
a control circuitry including a processor and a non-transitory memory device, the memory device including instructions that, when executed by the processor, adjust a position of the frame in response to a command from a caregiver, wherein, in response to the command, the control circuitry operates the at least one head section actuator to adjust the angle of the head section relative to the seat section to a predetermined angle, receives a status of the sensor to detect a height of the caregiver, and operates the at least one frame actuator to adjust a height of the frame based on the detected height of the caregiver,
wherein, in response to the command, the control circuitry further operates the air source to inflate at least one of the plurality of bladders.

2. The apparatus of claim 1, wherein the predetermined angle comprises a 25 degree angle.

3. The apparatus of claim 1, wherein the predetermined angle comprises a 45 degree angle.

4. The apparatus of claim 1, wherein, in response to the command, the control circuitry further operates the air source to inflate the at least one of the plurality of bladders to a maximum volume.

5. The apparatus of claim 1, wherein the sensor detects the height of the caregiver by scanning the caregiver.

6. The apparatus of claim 1, wherein the control circuitry operates the at least one frame actuator to adjust the height of the frame based on the detected height of the caregiver relative to the golden ratio.

7. The apparatus of claim 1, wherein the at least one frame actuator adjusts the height of the frame so that a head of bed axis is aligned with an ombilicus of the caregiver.

8. The apparatus of claim 1, wherein the at least one frame actuator adjusts the height of the frame so that a laryngeal axis of a patient on the patient support surface is approximately aligned with a line of vision of the caregiver.

9. The apparatus of claim 1, wherein the at least one frame actuator adjusts the height of the frame so that a pharyngeal axis of a patient on the patient support surface is approximately aligned with a line of vision of the caregiver.

10. The apparatus of claim 1, wherein the at least one frame actuator adjusts the height of the frame so that an oral axis of a mouth of a patient on the patient support surface is approximately aligned with a line of vision of the caregiver.

11. The apparatus of claim 1, further comprising an activation button, wherein the command from the caregiver is received when the activation button is actuated.

12. The apparatus of claim 1, wherein the command from the caregiver is received when a patient positioned on the patient support surface requires intubation.

13. The apparatus claim 1, wherein the source of air comprises at least one of a fan, a blower, a pump, and a compressor.

14. A patient support apparatus, comprising:
a frame having a head section moveably coupled to a seat section,
at least one frame actuator configured to raise and lower the frame relative to a floor,
at least one head section actuator configured to adjust an angle of the head section relative to the seat section,
a patient support surface positioned on the frame,
a sensor configured to detect the presence of a caregiver at a head end of the frame, and
a control circuitry including a processor and a non-transitory memory device, the memory device including instructions that, when executed by the processor, adjust a position of the frame in response to a command from a caregiver, wherein, in response to the command, the control circuitry operates the at least one head section actuator to adjust the angle of the head section relative to the seat section to a predetermined angle, receives a status of the sensor to detect a height of the caregiver, and operates the at least one frame actuator to adjust a height of the frame based on the detected height of the caregiver.

15. The apparatus of claim 14, wherein the predetermined angle comprises at least one of a 25 degree angle and a 45 degree angle.

16. The apparatus of claim 14, wherein the sensor detects the height of the caregiver by scanning the caregiver.

17. The apparatus of claim 14, wherein the control circuitry operates the at least one frame actuator to adjust the height of the frame based on the detected height of the caregiver relative to the golden ratio.

18. The apparatus of claim 14, wherein the at least one frame actuator adjusts the height of the frame so that a head of bed axis is aligned with an ombilicus of the caregiver.

19. The apparatus of claim 14, wherein the at least one frame actuator adjusts the height of the frame so that at least one of a laryngeal axis of a patient on the patient support surface is approximately aligned with a line of vision of the caregiver, a pharyngeal axis of the patient on the patient support surface is approximately aligned with the line of vision of the caregiver, and an oral axis of a mouth of the patient on the patient support surface is approximately aligned with the line of vision of the caregiver.

20. The apparatus of claim 14, wherein the command from the caregiver is received when a patient positioned on the patient support surface requires intubation.
